(19) United States
(12) Patent Application Publication
(10) Pub. No.: US 2026/0212301 A1
(43) Pub. Date: Jul. 23, 2026

(54) INFORMATION PROCESSING METHOD, INFORMATION PROCESSING DEVICE

(71) Applicant: Panasonic Intellectual Property Management Co., Ltd., Osaka (JP)

(72) Inventors: HIRONORI OHIGASHI, Osaka (JP); AKIRA MINEGISHI, Osaka (JP)

(21) Appl. No.: 19/141,731

(22) PCT Filed: Jan. 18, 2024
(86) PCT No.: PCT/JP2024/001271

§ 371 Date: Jun. 20, 2025

(30) Foreign Application Priority Data
Feb. 1, 2023 (JP) 2023-013811

(51) Int. Cl. G06Q 10/0637

(52) U.S. Cl. CPC G06Q 10/0637

(57) ABSTRACT

Provided is an information processing method capable of evaluating and updating a production plan based on an estimation result of a current production capability regarding a production facility. An information processing method is an information processing method for updating a production plan for producing a product by using a production facility. The method includes, by an information processing device, estimating a current production capability regarding the production facility based on production performance data indicating a performance value of a production capability of the production facility, evaluating the production plan based on the estimated current production capability, and updating the production plan based on a result of the evaluation.

### TECHNICAL FIELD

The present disclosure relates to an information processing method, an information processing device, and a program.

### BACKGROUND ART

PTL 1 discloses a production plan creation device that creates a production plan of a manufacturing process including a plurality of work processes.

### CITATION LIST

### Patent Literature

PTL 1: Unexamined Japanese Patent Publication No. 2012-59032

### SUMMARY OF THE INVENTION

However, in PTL 1, no consideration is made on estimating a current production capability regarding a production facility and evaluating and updating a production plan based on an estimation result.

An object of the present disclosure is to provide an information processing method, an information processing device, and a program capable of evaluating and updating a production plan based on an estimation result of a current production capability regarding a production facility.

An information processing method according to one aspect of the present disclosure is an information processing method for updating a production plan for producing a product by using a production facility. The method includes, by an information processing device, estimating a current production capability regarding the production facility based on production performance data indicating a performance value of a production capability of the production facility, evaluating the production plan based on the estimated current production capability, and updating the production plan based on a result of the evaluation. An information processing device according to another aspect of the present disclosure is an information processing device for updating a production plan for producing a product by using a production facility. The device includes an estimation part that estimates a current production capability regarding the production facility based on production performance data indicating a performance value of a production capability of the production facility, an evaluation part that evaluates the production plan based on the current production capability estimated by the estimation part, and an update part that updates the production plan based on a result of the evaluation by the evaluation part.

A program according to still another aspect of the present disclosure causes an information processing device for updating a production plan for producing a product by using a production facility to execute a function of estimating a current production capability regarding the production facility based on production performance data indicating a performance value of a production capability of the production facility, evaluating the production plan based on the current production capability estimated by the estimation means, and updating the production plan based on a result of the evaluation by the evaluation means.

In accordance with the present disclosure, it is possible to evaluate and update the production plan at an early stage based on the estimation result of the current production capability regarding the production facility, and as a result, it is possible to reduce the due date delay risk and facilitate on-site handling.

### BRIEF DESCRIPTION OF THE DRAWINGS

FIG. 1 is a diagram illustrating a configuration of a production plan management apparatus according to an exemplary embodiment of the present disclosure.

FIG. 2 is a diagram illustrating production capability information in a simplified manner.

FIG. 3 is a diagram illustrating switching time information in a simplified manner.

FIG. 4 is a diagram illustrating order information in a simplified manner.

FIG. 5 is a diagram illustrating production performance data in a simplified manner.

FIG. 6 is a diagram illustrating switching performance data in a simplified manner.

FIG. 7 is a diagram illustrating processing of estimating a current production capability.

FIG. 8 is a diagram illustrating processing of estimating a current switching time.

FIG. 9 is a diagram illustrating production plan information in a simplified manner.

FIG. 10 is a diagram illustrating a case where a part of jobs included in the production plan information is extracted.

FIG. 11 is a flowchart illustrating a flow of processing executed by an information processing part.

FIG. 12 is a diagram illustrating a simulation result of production plan information in a simplified manner.

FIG. 13 is a diagram illustrating processing of updating the production plan information in a simplified manner.

FIG. 14 is a diagram illustrating processing of updating the production plan information in a simplified manner.

FIG. 15 is a diagram illustrating processing of updating the production plan information in a simplified manner.

FIG. 16 is a diagram illustrating processing of updating the production plan information in a simplified manner.

### DESCRIPTION OF EMBODIMENT

### Knowledge as Basis of Present Disclosure

In a production line that produces a plurality of product types of products by using a plurality of production facilities, a production plan is formulated such that a due date delay does not occur, and an operation of each production facility is managed according to the production plan. For the production plan, for example, a plan for a current month is formulated on a first operating day of each month.

However, a production capability (production amount per unit time) of each production facility fluctuates every day due to various factors including mechanical troubles and the like. Thus, in a case where production does not proceed according to the production plan and a due date delay occurs or in a case where a possibility of the due date delay is high, it is necessary to review the production plan.

However, when the production plan is updated after the due date delay occurs or immediately before the due date delay occurs, it is difficult to respond to a site in the production line or the like, and another mistake may be induced.

In order to solve such a problem, the inventors of the present invention have found that the production plan can be updated early by estimating a current production capability based on production performance data indicating an actual value of the production capability of the production facility and evaluating the production plan based on the estimated current production capability and have arrived at the present disclosure.

Next, an exemplary embodiment of the present disclosure will be described.

### Exemplary Embodiment of Present Disclosure

Hereinafter, an exemplary embodiment of the present disclosure will be described in detail with reference to the drawings. Elements denoted by identical reference marks in different drawings indicate identical or corresponding elements. In addition, constituent elements, disposition positions of the constituent elements, connection forms, order of operations, and the like illustrated in the following exemplary embodiment are merely examples, and are not intended to limit the present disclosure. The present disclosure is limited only by the scope of the claims. Accordingly, among the constituent elements in the following exemplary embodiment, constituent elements not described in the independent claims indicating the highest concept of the present disclosure are not necessarily required to achieve the object of the present disclosure, but are described as constituting a more preferable mode.

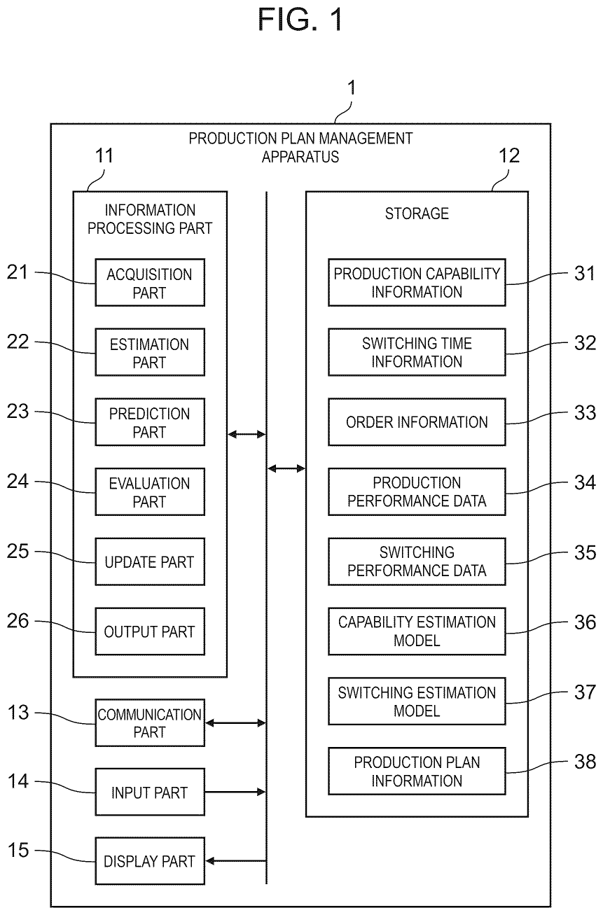

FIG. 1 is a diagram illustrating a configuration of production plan management apparatus 1 according to an exemplary embodiment of the present disclosure. Production plan management apparatus 1 includes information processing part 11, storage 12, communication part 13, input part 14, and display part 15. Production plan management apparatus 1 may be a dedicated terminal, or may be a general-purpose personal computer or the like.

Information processing part 11 is constituted by using a processor (information processing device) such as a central processing part (CPU) or a graphics processing unit (GPU). Storage 12 is constituted by using a hard disc drive (HDD), a solid state drive (SSD), a semiconductor memory, or the like. Communication part 13 is constituted by using a communication module compatible with any communication standard such as Bluetooth (registered trademark) or Wi-Fi (registered trademark). Input part 14 is constituted by using any input device such as a touch panel, a mouse, or a keyboard. Display part 15 is constituted by using, for example, a liquid crystal display or an organic electroluminescence (EL) display. Note that, information processing part 11 may be implemented in an external terminal or a server device capable of communicating with production plan management apparatus 1. The external terminal includes a personal computer, a smartphone, a tablet terminal, or the like. The server device includes an edge server, a cloud server, or the like.

Storage 12 stores production capability information 31, switching time information 32, order information 33, production performance data 34, switching performance data 35, capability estimation model 36, switching estimation model 37, and production plan information 38. Production capability information 31, switching time information 32, order information 33, production performance data 34, and switching performance data 35 are input from communication part 13 or input part 14 to storage 12, and storage 12 retains these pieces of information and data.

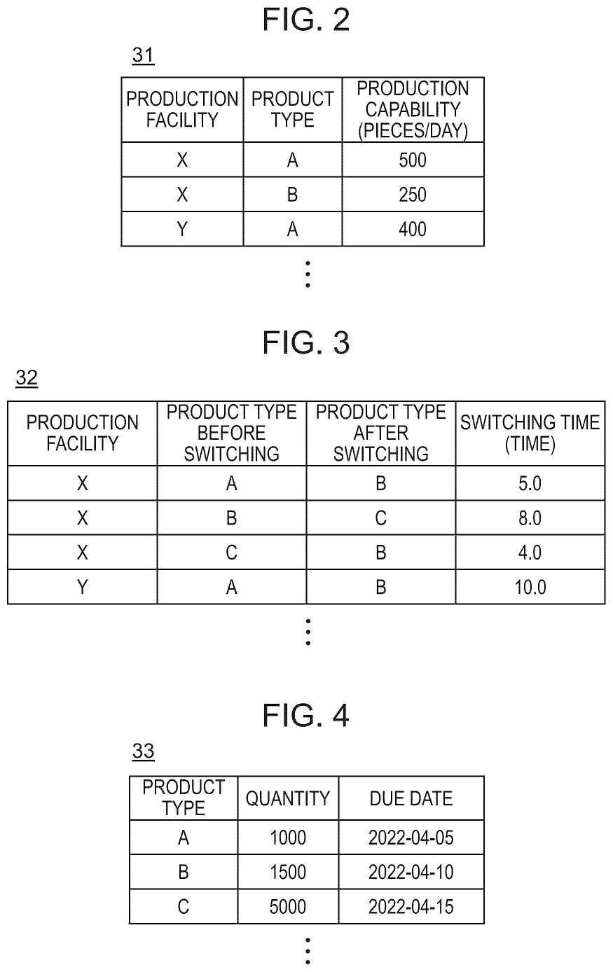

FIG. 2 is a diagram illustrating production capability information 31 in a simplified manner. Production capability information 31 is a database having a plurality of items of a production facility, a product type, and a production capability (pieces/day). The product type and the production capability that can be produced vary depending on the production facility. For example, a production capability at the time of producing product type A by production facility X is a maximum of 500 per day.

FIG. 3 is a diagram illustrating switching time information 32 in a simplified manner. Switching time information 32 is a database having a plurality of items of a production facility, a product type before switching, a product type after switching, and a switching time (time). The switching time is a time required to switch a product to be produced by a certain production facility from a certain product type to another product type. The switching time varies depending on the production facility, the product type before switching, and the product type after switching. For example, a switching time in a case where the product to be produced by production facility X is switched from product type A to product type B is 5.0 hours.

FIG. 4 is a diagram illustrating order information 33 in a simplified manner. Order information 33 is a database having a plurality of items of a product type, a quantity, and a due date. For example, it is necessary to deliver 1000 product types A by Apr. 5, 2022 (written as 2022-04-05).

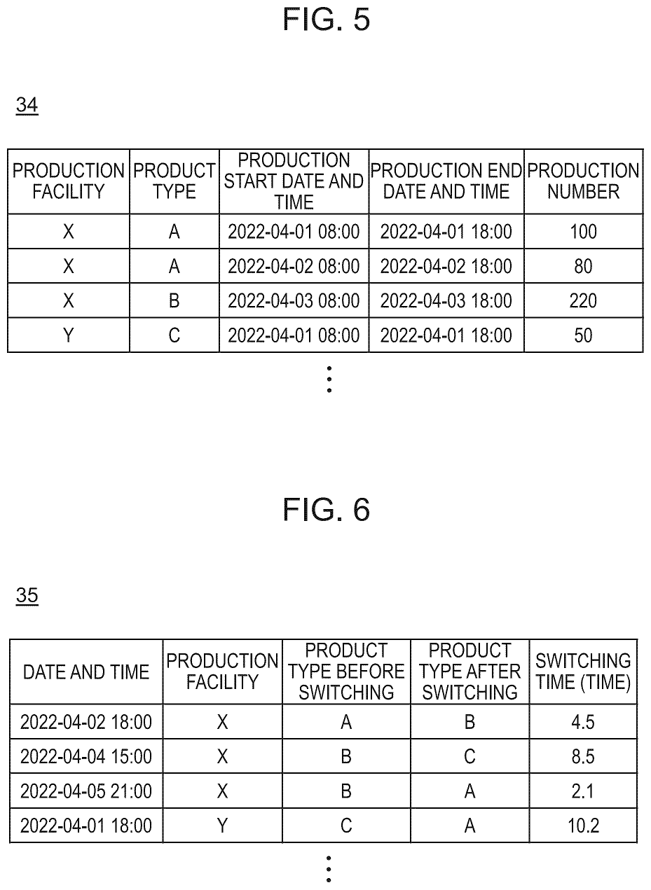

FIG. 5 is a diagram illustrating production performance data 34 in a simplified manner. Production performance data 34 is a database including a plurality of items of a production facility, a product type, a production start date and time, a production end date and time, and a production number, and indicates a performance value of a production capability of the production facility. For example, 100 product types A were produced by production facility X from 8:00, Apr. 1, 2022 (written as 2022-04-01 08:00) to 18:00, Apr. 1, 2022 (written as 2022-04-01 18:00). Production performance data 34 includes a post-update performance value which is a performance value after previous updating of production plan information 38 and a pre-update performance value which is a performance value before the previous updating of the production plan.

FIG. 6 is a diagram illustrating switching performance data 35 in a simplified manner. Switching performance data 35 is a database having a plurality of items of a date and time, a production facility, a product type before switching, a product type after switching, and a switching time (time), and indicates a performance value of the switching time. For example, a work of switching from product type A to product type B was performed in production facility X at 18:00, Apr. 2, 2022 (written as 2022-04-02 18:00), and a switching time at that time was 4.5 hours. Switching performance data 35 includes a post-update performance value that is a performance value after the previous updating of production plan information 38 and a pre-update performance value that is a performance value before the previous updating of the production plan.

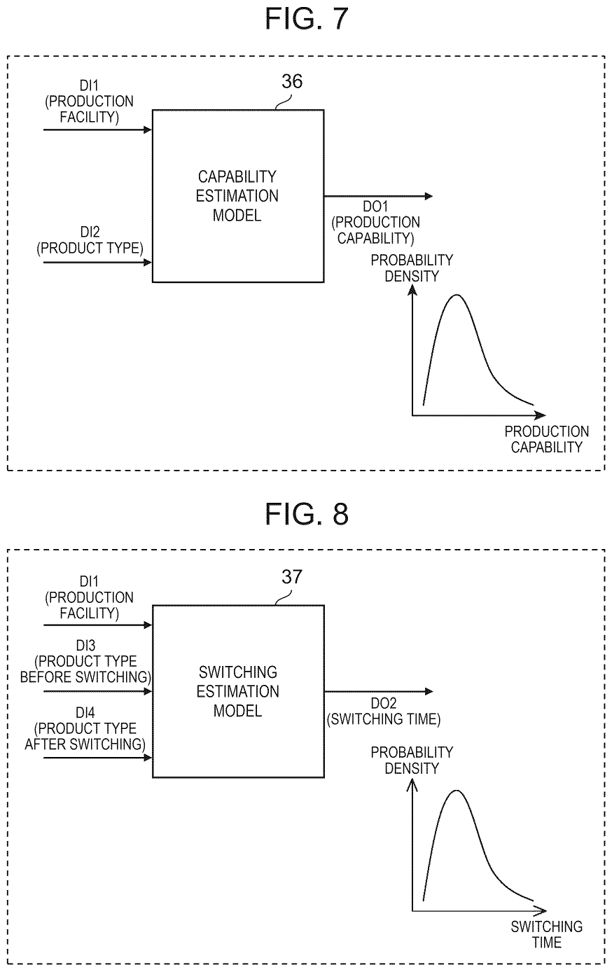

FIG. 7 is a diagram illustrating processing of estimating the current production capability using capability estimation model 36. capability estimation model 36 is, for example, an estimation model using Bayesian estimation, and machine learning is performed by using production performance data 34. capability estimation model 36 estimates the current production capability of each production facility based on production performance data 34. Production performance data 34 includes the post-update performance value and the pre-update performance value, and in a case where a current estimation capability is estimated by weight average of the post-update performance value and the pre-update performance value, a weight value of the post-update performance value may be set to be higher than a weight value of the pre-update performance value. Pieces of input data DI1 and DI2 are input to capability estimation model 36, and output data DO1 is output from capability estimation model 36. Input data DI1 indicates the production facility, input data DI2 indicates the product type, and output data DO1 indicates a probability distribution of the production capability. A horizontal axis of output data DO1 represents the production capability, and a vertical axis represents a probability density. That is, capability estimation model 36 is a machine-learned estimation model in which the production facility and the product type of the product are used as explanatory variables and the probability distribution of the production capability is used as an objective variable. Any algorithm capable of estimating a distribution of the probability density with respect to a continuous value, such as random forest, neural network, gradient boosting, or linear regression, can be used as an algorithm of the estimation model.

FIG. 8 is a diagram illustrating processing of estimating a current switching time using switching estimation model 37. Switching estimation model 37 is, for example, an estimation model using Bayesian estimation, and machine learning is performed by using switching performance data 35. Switching estimation model 37 estimates a current switching time regarding each production facility based on switching performance data 35. Switching performance data 35 includes the post-update performance value and the pre-update performance value. Here, in a case where the current switching time is estimated by the weight average of the post-update performance value and the pre-update performance value, the weight value of the post-update performance value may be set to be higher than the weight value of the pre-update performance value. Pieces of input data DI1, DI3, and DI4 are input to switching estimation model 37. Output data DO2 is output from switching estimation model 37. Input data DI1 indicates the production facility, input data DI3 indicates the product type before switching, input data DI4 indicates the product type after switching, and output data DO2 indicates the probability distribution of the switching time. A horizontal axis of output data DO2 is the switching time, and a vertical axis is the probability density. That is, switching estimation model 37 is a machine-learned estimation model in which the production facility, the product type before switching, and the product type after switching are used as explanatory variables, and the probability distribution of the switching time is used as an objective variable. Any algorithm capable of estimating a distribution of the probability density with respect to a continuous value, such as random forest, neural network, gradient boosting, or linear regression, can be used as an algorithm of the estimation model.

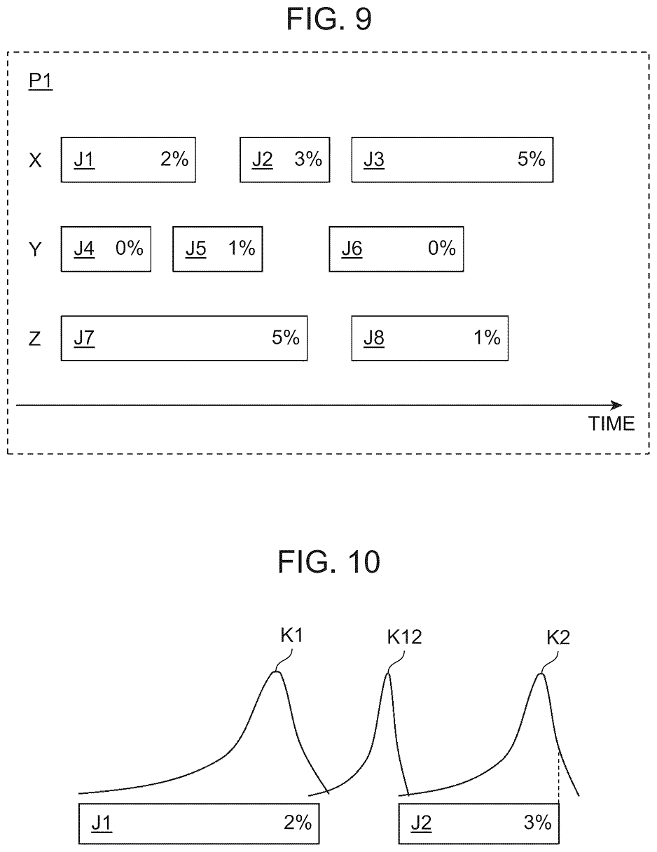

FIG. 9 is a diagram illustrating current production plan information 38 previously updated and stored in storage 12 in a simplified manner. Production plan information 38 has array pattern Pl of a plurality of jobs J1 to J8 in which products to be produced by production facilities are arrayed in time series for each product type. A horizontal axis represents a time, and production facilities X to Z are classified in a vertical axis direction. A gap between two jobs adjacent in a horizontal axis direction is the switching time. Production facility X sequentially processes jobs J1 to J3, production facility Y sequentially processes jobs J4 to J6, and production facility Z sequentially processes jobs J7 and J8. A length of each job J in the horizontal axis direction corresponds to a required production time. A probability value of occurrence of a due date delay for the job is written at the end of each job J. For example, a probability of occurrence of a due date delay for job J1 is 2%.

FIG. 10 is a diagram illustrating a case where some jobs J1 and J2 included in production plan information 38 are extracted. A required production time related to job J1, a switching time between jobs J1 and J2, and a required production time related to job J2 are defined as probability distributions K1, K12, and K2, respectively. For example, regarding job J2, an integral value of a portion of probability distribution K2 positioned to the right of a right end of job J2 corresponds to an occurrence probability of a due date delay regarding job J2.

As illustrated in FIG. 1, information processing part 11 includes acquisition part 21, estimation part 22, prediction part 23, evaluation part 24, update part 25, and output part 26 as functions realized by a processor executing a program read from a non-volatile recording medium such as a computer-readable read only memory (ROM). In other words, the program is a program for causing information processing part 11 as an information processing device mounted on production plan management apparatus 1 to function as acquisition part 21, estimation part 22, prediction part 23, evaluation part 24, update part 25, and output part 26. Details of processing contents executed by each processing part will be described later.

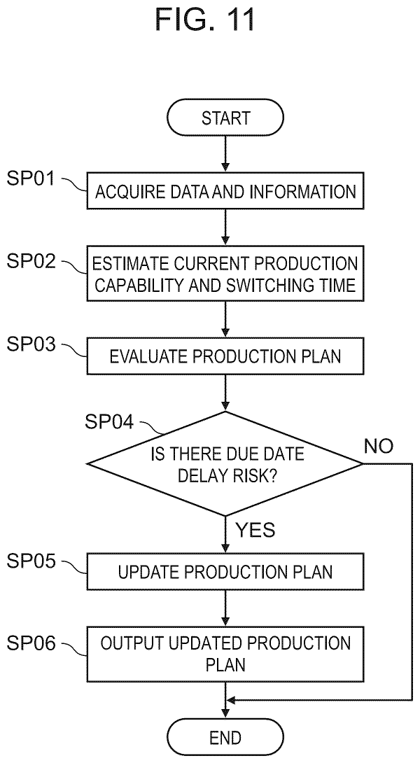

FIG. 11 is a flowchart illustrating a flow of processing executed by information processing part 11.

First, in step SP01, acquisition part 21 reads and acquires production capability information 31, switching time information 32, order information 33, production performance data 34, and switching performance data 35 from storage 12.

Subsequently, in step SP02, estimation part 22 estimates a current production capability regarding each production facility based on production performance data 34 by using capability estimation model 36. In addition, estimation part 22 estimates a current switching time regarding each production facility based on switching performance data 35 by using switching estimation model 37.

Subsequently, in step SP03, prediction part 23 executes a simulation for evaluating current production plan information 38 by using the current production capability and the current switching time estimated by estimation part 22. That is, prediction part 23 predicts current production plan information 38 illustrated in FIG. 9 by recalculating the required production time of each job J and the switching time between adjacent jobs J by using the current production capability and the current switching time estimated by estimation part 22. In addition, prediction part 23 performs prediction by recalculating the occurrence probability of the due date delay for each job J.

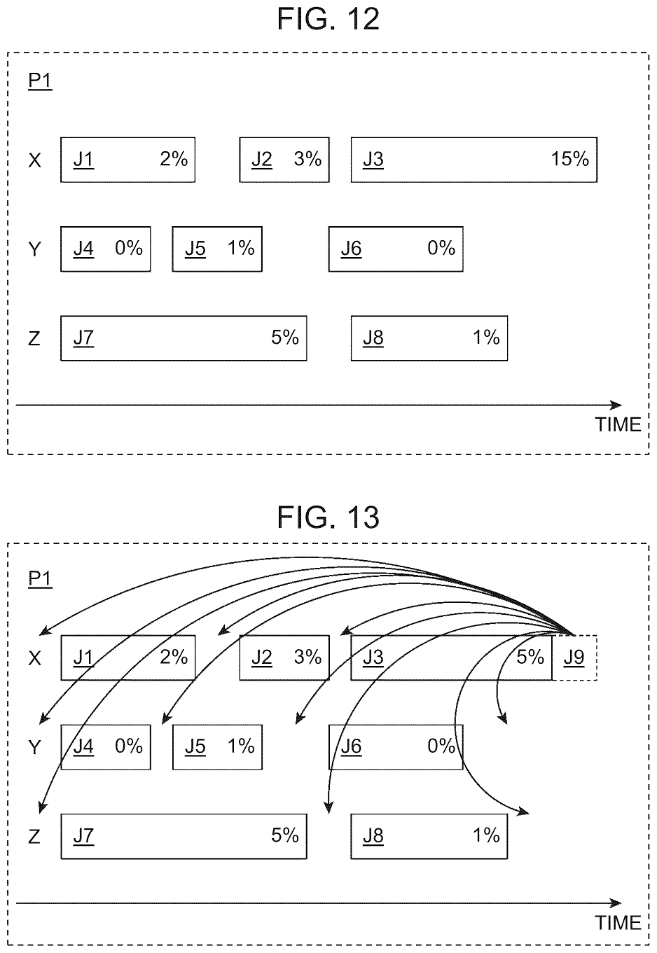

FIG. 12 is a diagram illustrating a simulation result of production plan information 38 after step SP03 in a simplified manner. An occurrence probability of a due date delay regarding job J3 was 5% at the time of the previous updating (FIG. 9), but has increased to 15% in the simulation result.

Subsequently, as illustrated in FIG. 11, in step SP04, evaluation part 24 determines whether or not there is a due date delay risk in the simulation result. An allowable value (for example, 5%) is set for the occurrence probability of the due date delay, and evaluation part 24 determines that there is the due date delay risk when there is job J in which the occurrence probability of the due date delay exceeds the allowable value, and determines that there is no due date delay risk when there is no job J in which the occurrence probability of the due date delay exceeds the allowable value.

In a case where it is determined that there is no due date delay risk (step SP04: NO), the processing ends without updating current production plan information 38.

Subsequently, in a case where it is determined that there is the due date delay risk (step SP04: YES), in step SP05, update part 25 updates current production plan information 38.

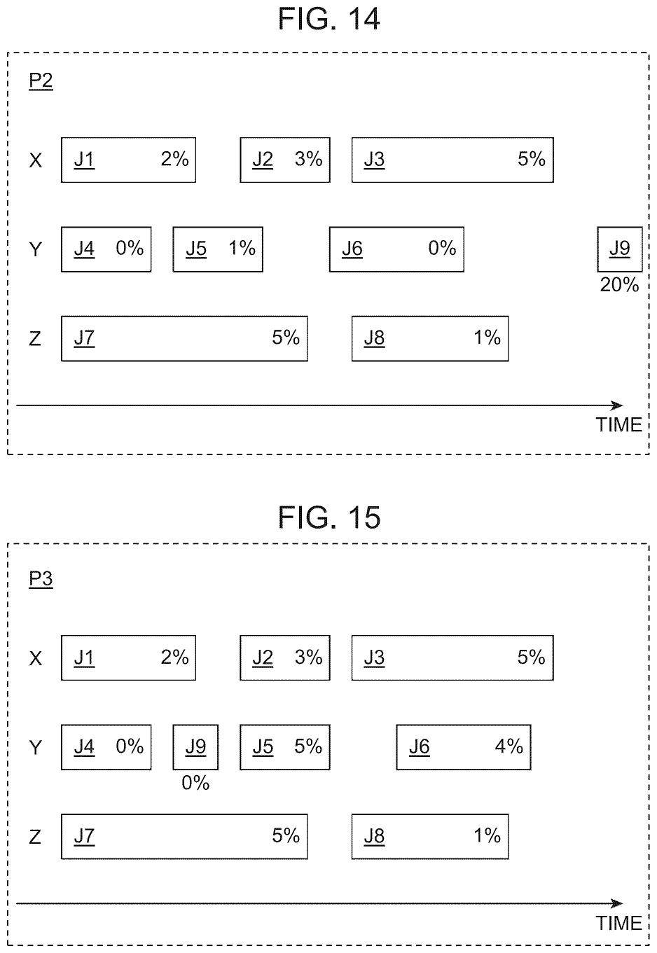

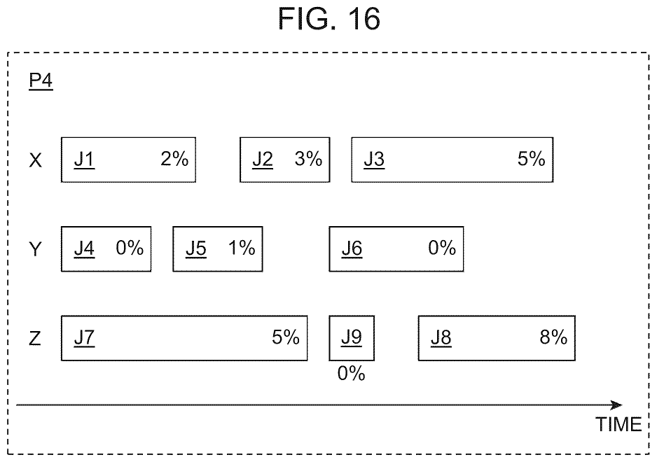

FIGS. 13 to 16 are diagrams illustrating processing of updating production plan information 38 in a simplified manner. FIG. 13 is a diagram illustrating that update part 25 cuts out, as new job J9, an excess portion of job J3 in which the occurrence probability of the due date delay exceeds the allowable value, that exceeds the allowable value, from the job J3 and sequentially inserts the excess portion between other jobs J to change array pattern P. FIG. 14 is a diagram in a case where new job J9 is inserted after job J6. FIG. 15 is a diagram in a case where new job J9 is inserted between jobs J4 and J5. FIG. 16 is a diagram in a case where new job J9 is inserted between jobs J7 and J8.

As illustrated in FIG. 13, first, update part 25 cuts out, as new job J9, an excess portion of job J3 in which the occurrence probability of the due date delay exceeds the allowable value from job J3. Subsequently, update part 25 sequentially inserts cut-out excess job J9 between other jobs J to change array pattern P to re-execute the above simulation for each array pattern P.

As illustrated in FIG. 14, in a case where job J9 is inserted after job J6 as in array pattern P2, since a switching time between jobs J6 and J9 is very long, an occurrence probability of a due date delay regarding job J9 is 20% exceeding the allowable value.

As illustrated in FIG. 15, in a case where job J9 is inserted between jobs J4 and J5 as in array pattern P3, the occurrence probability of the due date delay is less than or equal to the allowable value for all jobs JI to J9.

As illustrated in FIG. 16, in a case where job J9 is inserted between jobs J7 and J8 as in array pattern P4, an occurrence probability of a due date delay regarding job JS is 8% exceeding the allowable value, and the occurrence probability of the due date delay is less than or equal to the allowable value for other jobs JI to J7 and J9.

In step SP05, update part 25 determines, as an optimal array pattern, array pattern P3 in which the occurrence probability of the due date delay is less than or equal to the allowable value for all jobs JI to J9, and updates production plan information 38 in accordance with the optimal array pattern.

Subsequently, as illustrated in FIG. 11, in step SP06, output part 26 outputs production plan information 38 updated by update part 25. Output updated production plan information 38 is input to display part 15 and is displayed on a display screen of display part 15.

In a case where there is no array pattern P3 in which the occurrence probability of the due date delay is less than or equal to the allowable value for all jobs JI to J9, update part 25 determines, as an optimal array pattern, array pattern P4 in which a maximum value of the occurrence probability of the due date delay for all jobs J1 to J9 is minimum, and updates production plan information 38 in accordance with the optimal array pattern.

Subsequently, in this case, in step SP06, output part 26 outputs production plan information 38 updated by update part 25 together with an alert indicating that there is no array pattern in which the occurrence probability of the due date delay is less than or equal to the allowable value for all the jobs. Output updated production plan information 38 and the alert are input to display part 15 and are displayed on a display screen of display part 15.

In accordance with production plan management apparatus 1 according to the present exemplary embodiment, estimation part 22 estimates the current production capability regarding the production facility, and thus, update part 25 can evaluate and update the production plan at an early stage based on the estimation result. As a result, it is possible to reduce the due date delay risk and facilitate on-site handling.

In addition, estimation part 22 further estimates the current switching time regarding the production facility, and thus, evaluation part 24 can evaluate the production plan based on the estimation results of both the current production capability and the current switching time. As a result, the evaluation accuracy can be improved.

In addition, evaluation part 24 evaluates the occurrence probability of the due date delay for each of the plurality of jobs, and thus, quantitative evaluation can be performed.

In addition, since the array of the remaining jobs other than the jobs before and after the excess portion is inserted is not changed, it is possible to minimize a changed portion of the production plan. As a result, it is possible to facilitate on-site handling accompanying the updating of the production plan.

### Aspects

The following aspects of the present disclosure are derived from the exemplary embodiment described above. Each aspect of the present disclosure will be described below.

An information processing method according to a first aspect of the present disclosure is an information processing method for updating a production plan for producing a product by using a production facility. The method includes, by an information processing device, estimating a current production capability regarding the production facility based on production performance data indicating a performance value of a production capability of the production facility, evaluating the production plan based on the estimated current production capability, and updating the production plan based on a result of the evaluation.

In accordance with the first aspect, the current production capability regarding the production facility is estimated, and thus, it is possible to evaluate and update the production plan at an early stage based on the estimation result. As a result, it is possible to reduce the due date delay risk and facilitate on-site handling.

In an information processing method according to a second aspect of the present disclosure, in the first aspect, a machine-learned estimation model in which the production facility and a product type of the product are used as explanatory variables and a probability distribution of the production capability may be used as an objective variable is used in the estimation of the current production capability.

In accordance with the second aspect, the estimation accuracy can be improved by using the machine-learned estimation model in the estimation of the current production capability. In addition, the objective variable of the estimation model is used as the probability distribution of the production capability, and thus, it is possible to evaluate the occurrence risk of the due date delay as a probability value.

In an information processing method according to a third aspect of the present disclosure, in the first or second aspect, the production performance data may include a post-update performance value that is a performance value after previous updating of the production plan and a pre-update performance value that is a performance value before the previous updating of the production plan.

In accordance with the third aspect, the production performance data includes not only the pre-update performance value but also the post-update performance value, and thus, it is possible to perform estimation in consideration of a situation after the previous updating of the production plan. As a result, it is possible to improve the estimation accuracy.

In an information processing method according to a fourth aspect of the present disclosure, in the third aspect, a weight value of the post-update performance value may be set to be higher than a weight value of the pre-update performance value.

In accordance with the fourth aspect, it is possible to perform estimation focusing on the situation after the updating rather than before the previous updating of the production plan, and as a result, it is possible to improve the estimation accuracy.

In an information processing method according to a fifth aspect of the present disclosure, in any one of the first to fourth aspects, the method may further include estimating a current switching time regarding the production facility based on switching performance data indicating a performance value of a switching time required to switch a product to be produced by the production facility from a certain product type to another product type. In the evaluation of the production plan, the production plan is evaluated based on the estimated current production capability and the estimated current switching time.

In accordance with the fifth aspect, the current switching time regarding the production facility is further estimated, and thus, the production plan can be evaluated based on the estimation results of both the current production capability and the current switching time. As a result, the evaluation accuracy can be improved.

In an information processing method according to a sixth aspect of the present disclosure, in the fifth aspect, a machine-learned estimation model in which the production facility, a product type of the product before switching, and a product type of the product after switching are used as explanatory variables and a probability distribution of the switching time is used as an objective variable may be used in the estimation of the current switching time.

In accordance with the sixth aspect, the estimation accuracy can be improved by using the machine-learned estimation model in the estimation of the current switching time. In addition, the objective variable of the estimation model is used as the probability distribution of the switching time, and thus, it is possible to evaluate the occurrence risk of the due date delay as a probability value.

In an information processing method according to a seventh aspect of the present disclosure, in the fifth or sixth aspect, the switching performance data may include a post-update performance value that is a performance value after previous updating of the production plan and a pre-update performance value that is a performance value before the previous updating of the production plan.

In accordance with the seventh aspect, the production performance data includes not only the pre-update performance value but also the post-update performance value, and thus, it is possible to perform estimation in consideration of a situation after the previous updating of the production plan. As a result, it is possible to improve the estimation accuracy.

In an information processing method according to an eighth aspect of the present disclosure, in the seventh aspect, a weight value of the post-update performance value may be set to be higher than a weight value of the pre-update performance value.

In accordance with the eighth aspect, it is possible to perform estimation focusing on the situation after the updating rather than before the previous updating of the production plan, and as a result, it is possible to improve the estimation accuracy.

In an information processing method according to a ninth aspect of the present disclosure, in any one of the first to eighth aspects, in the evaluation of the production plan, a simulation of a probability distribution of a production time may be executed based on the estimated current production capability for each of a plurality of jobs in which products to be produced by the production facility are arrayed in time series for each product type, and an occurrence probability of a due date delay may be evaluated for each of the plurality of jobs.

In accordance with the ninth aspect, quantitative evaluation can be performed by evaluating the occurrence probability of the due date delay for each of the plurality of jobs.

In an information processing method according to a tenth aspect of the present disclosure, in the ninth aspect, in the updating of the production plan, an excess portion of the job in which the occurrence probability of the due date delay exceeds an allowable value, that exceeds the allowable value, may be cut out from the job, the cut excess portion may be sequentially inserted between other jobs to re-execute the simulation, an array pattern in which the occurrence probability of the due date delay is less than or equal to the allowable value for all the jobs or an array pattern in which a maximum value of the occurrence probability of the due date delay for all the jobs is minimum may be determined as an optimal array pattern, and the production plan may be updated in association with the optimal array pattern.

In accordance with the tenth aspect, since the array of the remaining jobs other than the jobs before and after the excess portion is inserted is not changed, it is possible to minimize the changed portion of the production plan. As a result, it is possible to facilitate on-site handling accompanying the updating of the production plan.

An information processing device according to an eleventh aspect of the present disclosure is an information processing device for updating a production plan for producing a product by using a production facility. The device includes an estimation part that estimates a current production capability regarding the production facility based on production performance data indicating a performance value of a production capability of the production facility, an evaluation part that evaluates the production plan based on the current production capability estimated by the estimation part, and an update part that updates the production plan based on a result of the evaluation by the evaluation part.

In accordance with the eleventh aspect, the current production capability regarding the production facility is estimated, and thus, it is possible to evaluate and update the production plan at an early stage based on the estimation result. As a result, it is possible to reduce the due date delay risk and facilitate on-site handling.

A program according to a twelfth aspect of the present disclosure is a program for causing an information processing device for updating a production plan for producing a product by using a production facility to execute a function of estimating a current production capability regarding the production facility based on production performance data indicating a performance value of a production capability of the production facility, evaluating the production plan based on the current production capability estimated by the estimation means, and updating the production plan based on a result of the evaluation by the evaluation means.

In accordance with the twelfth aspect, the current production capability regarding the production facility is estimated, and thus, it is possible to evaluate and update the production plan at an early stage based on the estimation result. As a result, it is possible to reduce the due date delay risk and facilitate on-site handling.

The present disclosure can also be realized as a program for causing a computer to execute each characteristic configuration included in such a method or device, or a system that operates by the program. In addition, it goes without saying that such a computer program can be distributed via a computer-readable non-transitory recording medium such as a CD-ROM or a communication network such as the Internet.

### INDUSTRIAL APPLICABILITY

The present disclosure is particularly useful for application to a production plan management system that manages a production plan for producing various product types of products by using a plurality of production facilities.

### REFERENCE MARKS IN THE DRAWINGS

1: production plan management apparatus
11: information processing part
22: estimation part
23: prediction part
24: evaluation part
25: update part
34: production performance data
35: switching performance data
36: capability estimation model
37: switching estimation model
38: production plan information

1. An information processing method for updating a production plan for producing a product by using a production facility, the method comprising:
by an information processing device,
estimating a current production capability regarding the production facility based on production performance data indicating a performance value of a production capability of the production facility;
evaluating the production plan based on the current production capability estimated; and
updating the production plan based on a result of the evaluating.

2. The information processing method according to claim 1, wherein a machine-learned estimation model in which the production facility and a product type of the product are used as explanatory variables and a probability distribution of the production capability is used as an objective variable is used in the estimating of the current production capability.

3. The information processing method according to claim 1, wherein the production performance data includes a post-update performance value that is a performance value after previous updating of the production plan and a pre-update performance value that is a performance value before the previous updating of the production plan.

4. The information processing method according to claim 3, wherein a weight value of the post-update performance value is set to be higher than a weight value of the pre-update performance value.

5. The information processing method according to claim 1, further comprising:
estimating a current switching time regarding the production facility based on switching performance data indicating a performance value of a switching time required to switch a product to be produced by the production facility from a certain product type to another product type,
wherein, in the evaluating of the production plan, the production plan is evaluated based on the estimated current production capability and the estimated current switching time.

6. The information processing method according to claim 5, wherein a machine-learned estimation model in which the production facility, a product type of the product before switching, and a product type of the product after switching are used as explanatory variables and a probability distribution of the switching time is used as an objective variable is used in the estimating of the current switching time.

7. The information processing method according to claim 5, wherein the switching performance data includes a post-update performance value that is a performance value after previous updating of the production plan and a pre-update performance value that is a performance value before the previous updating of the production plan.

8. The information processing method according to claim 7, wherein a weight value of the post-update performance value is set to be higher than a weight value of the pre-update performance value.

9. The information processing method according to claim 1,
wherein, in the evaluating of the production plan, a simulation of a probability distribution of a production time is executed based on the estimated current production capability for each of a plurality of jobs in which products to be produced by the production facility are arrayed in time series for each product type, and
an occurrence probability of a due date delay is evaluated for each of the plurality of jobs.

10. The information processing method according to claim 9,
wherein, in the updating of the production plan,
an excess portion of the job in which the occurrence probability of the due date delay exceeds an allowable value, that exceeds the allowable value, is cut out from the job,
the cut excess portion is sequentially inserted between other jobs to re-execute the simulation,
an array pattern in which the occurrence probability of the due date delay is less than or equal to the allowable value for all the jobs or an array pattern in which a maximum value of the occurrence probability of the due date delay for all the jobs is minimum is determined as an optimal array pattern, and
the production plan is updated in association with the optimal array pattern.

11. An information processing device for updating a production plan for producing a product by using a production facility, the device comprising:
an estimation part that estimates a current production capability regarding the production facility based on production performance data indicating a performance value of a production capability of the production facility;
an evaluation part that evaluates the production plan based on the current production capability estimated by the estimation part; and
an update part that updates the production plan based on a result of the evaluation by the evaluation part.

12. (canceled)
